(19) United States
(12) Patent Application Publication
(10) Pub. No.: US 2010/0101136 A1
(43) Pub. Date: Apr. 29, 2010

(54) ASYMMETRIC ONE-LEGGED WIRE GUIDE FOR FISHING ROD

(76) Inventor: Masaki TAKEMOTO, Niigata (JP)

Correspondence Address: WENDEROTH, LIND & PONACK, L.L.P., 1030 15th Street, N.W.,, Suite 400 East, Washington, DC, 20005-1503, US

(21) Appl. No.: 12/435,540

(22) Filed: May 5, 2009

(30) Foreign Application Priority Data
Oct. 27, 2008 (JP) 2008-275593

(51) Int. Cl. A01K 87/04

(52) U.S. Cl. 43/24

(57) ABSTRACT

The conventional wire guide, constructed as described above, has the following problems.

In the case of the above-mentioned construction of the line guide portion as illustrated in FIGS. 17 and 18, the angle formed by the portion where the line guide portion (4) and the fishing line are most strongly held in contact with each other, that is, the portion of the line guide (4) at maximum distance from the surface (21) of the fishing rod (1), and by the longitudinal direction of the base (3), that is, the advancing direction A of the fishing line (5), is a right angle (θ₄). Therefore, the slipping resistance offered to the fishing line, in particular, the resistance at the time of slipping start is large, which adversely affects the flying of the fishing line at the time of surf casting and the feel of use.

In order to solve this problem, an asymmetric one-legged wire guide for a fishing rod, comprising:

a loop-like line guide portion (4) formed by bending a single wire (10) and;

a pair of first linear leg (11) and second linear leg (15) formed respectively at both ends of the wire (10) and bundled together so as to be fore and aft with respect to each other in an advancing direction (A) of a fishing line (5) passing the line guide portion (4),

wherein an angle (θ₂) formed by a portion of the line guide portion (4) in contact with the fishing line (5) which is at maximum distance from a surface (21) of a fishing rod (1) and by a longitudinal direction (C) is an angle other than a right angle with respect to the longitudinal direction (C).

### BACKGROUND OF THE INVENTION

1. Field of the Invention

The present invention relates to an asymmetric one-legged wire guide for a fishing rod, in particular, to a novel improvement for preventing entanglement of a line guide portion and a fishing line and for reducing slipping resistance of the fishing line at the line guide portion.

2. Description of the Related Art

No patent application has been filed on a wire guide for a fishing rod of this type conventionally in use and on the market, and hence there is no disclosure in this regard in patent documents or the like. FIGS. 17, 18, and 19 illustrate a typical construction of a wire guide of this type.

In FIGS. 17, 18, and 19, a fishing rod is indicated by a reference numeral 1; a base 3 (corresponding to a leg) of a wire guide 2 is fixed to the surface of the fishing rod 1 through an intermediation of a fishing line (not shown), and a round-ring-shaped line guide portion 4 is integrally provided on the base 3.

The line guide portion 4 is constructed of a cylindrical body (not shown) formed of a single wire, ceramic material, or plastic or the like. When mounted to the fishing rod 1 in the state of the flat view of FIG. 17, the wire guide 2 enters the state as illustrated in FIG. 18. FIG. 19 is a perspective view illustrating how the wire guide as illustrated in FIG. 17 is twisted, and as illustrated in FIG. 18, the wire guide 2 is actually used in a vertical position.

The conventional wire guide, constructed as described above, has the following problems.

In the case of the above-mentioned construction of the line guide portion as illustrated in FIGS. 17 and 18, the angle formed by the portion where the line guide portion 4 and the fishing line are most strongly held in contact with each other, that is, the portion of the line guide 4 at maximum distance from the surface 21 of the fishing rod 1, and by the longitudinal direction of the base 3, that is, the advancing direction A of the fishing line 5, is a right angle θ₄. Therefore, the slipping resistance offered to the fishing line, in particular, the resistance at the time of slipping start is large, which adversely affects the flying of the fishing line at the time of surf casting and the feel of use.

In order to solve this problem, in the above-mentioned guide construction illustrated in FIG. 19, twisting is simply imparted to the line guide portion, whereby the angle θ₄ formed by the line guide portion 4 and the advancing direction A of the fishing line is not a right angle. In this case, however, it is obvious that the fishing line is easily allowed to get entangled with the leg portion of the guide.

### SUMMARY OF THE INVENTION

An asymmetric one-legged wire guide for a fishing rod according to the present invention includes a loop-like line guide portion formed by bending a single wire; and a pair of first linear leg and second linear leg formed respectively at both ends of the wire and bundled together so as to be fore and aft with respect to each other in the advancing direction of the fishing line passing the line guide portion, in which the angle formed by a portion of the wire forming the line guide portion in contact with the fishing line which is at maximum distance from the surface 21 of the fishing rod 1 and by the longitudinal direction is an angle other than a right angle with respect to the longitudinal direction. The angle of the above-mentioned portion with respect to the longitudinal direction ranges from 45 degrees to 80 degrees. The wire forming the line guide portion is continuously formed by an arcuate portion, a bent portion, and a linear portion. The respective legs exhibit different rising angles, and the difference in rising angle between the respective legs ranges from 30 degrees to 80 degrees. The legs are arranged side by side in the same plane, and the linear portion crosses the legs to form a crossing portion. The line guide portion is of an 8-shaped configuration in front view, and the legs extend in the direction of a rod base of the fishing rod.

The asymmetric one-legged wire guide for a fishing rod of the present invention, constructed as described above, provides the following effects.

A loop-like line guide portion is formed by bending a single wire, and a pair of first linear leg and second linear leg formed respectively at both ends of the wire are bundled together so as to be fore and aft with respect to each other in the advancing direction of the fishing line passing the line guide portion. The angle formed by a portion of the wire forming the line guide portion in contact with the fishing line which is at maximum distance from the surface 21 of the fishing rod 1 and by the longitudinal direction is an angle other than a right angle with respect to the longitudinal direction. The respective legs exhibit different rising angles, whereby the slipping resistance of the fishing line is reduced, and entanglement of the fishing line is prevented, making it possible to perform comfortable fishing.

Further, due to the construction in which the angle formed by the portion of the wire at maximum distance from the surface 21 of the fishing rod 1 and by the longitudinal direction ranges from 45 degrees to 80 degrees, it is possible to further enhance the above-mentioned effect.

Further, since the difference in rising angle between the respective legs ranges from 30 degrees to 80 degrees, it is possible to further enhance the above-mentioned effect.

Further, the wire forming the line guide portion is continuously formed by an arcuate portion, a bent portion, and a linear portion to be formed in an 8-shaped configuration in front view, whereby it is possible to substantially reduce the slipping resistance of the fishing line.

Further, the legs are arranged side by side in the same plane, whereby mounting to the fishing rod can be easily conducted.

The above-mentioned linear portion crosses the legs to form a crossing portion, whereby the assembly operation at the time of bundling of the legs arranged side by side is facilitated.

Further, the legs extend in the direction of the rod base, whereby mounting of the wire guide to the fishing rod is facilitated.

It is an object of the present invention to provide an asymmetric one-legged wire guide which prevents entanglement of the line guide and the fishing line and which helps to reduce the slipping resistance of the fishing line at the line guide portion.

### BRIEF DESCRIPTION OF THE DRAWINGS

In the accompanying drawings:

FIG. 1 is a flat view of an asymmetric one-legged wire guide for a fishing rod according to a first embodiment of the present invention;

FIG. 2 is a front view of FIG. 1;

FIG. 3 is a flat view of a second embodiment of the present invention;

FIG. 4 is a front view of FIG. 3;

FIG. 5 is a flat view of a third embodiment of the present invention;

FIG. 6 is a front view of FIG. 5;

FIG. 7 is a flat view of a fourth embodiment of the present invention;

FIG. 8 is a front view of FIG. 7;

FIG. 9 is a side view of legs of FIGS. 1 through 8;

FIG. 10 is a flat view of a jig used to perform working on the wire guide of the present invention;

FIG. 11 is a left-hand side view of FIG. 10;

FIG. 12 is a schematic view illustrating a first step in which working is performed on the wire guide by using the jig of the present invention;

FIG. 13 is a flat view of FIG. 12;

FIG. 14 is a schematic view of a second process according to the present invention;

FIG. 15 is a schematic view of a third process according to the present invention;

FIG. 16 includes a perspective view of a wire extracted from the jig of the present invention after working, and a perspective view illustrating how the wire legs are aligned and bundled together after working;

FIG. 17 is a flat view of a conventional wire guide;

FIG. 18 is a front view of FIG. 17; and

FIG. 19 is a flat view illustrating how the line guide portion of FIG. 17 is twisted.

### DETAILED DESCRIPTION OF THE PREFERRED EMBODIMENTS

In the following, preferred embodiments of the asymmetric one-legged wire guide for a fishing rod of the present invention are described with reference to the drawings.

The portions that are the same as or equivalent to those of the conventional example are indicated by the same reference numerals.

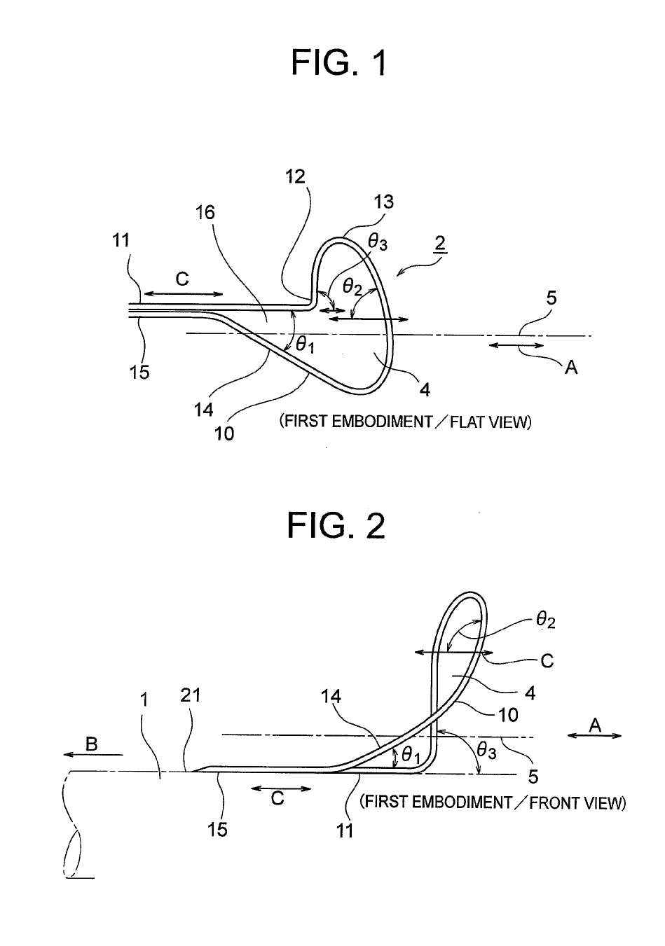

FIGS. 1 and 2 illustrate a first embodiment of the present invention. The wire guide 2 is fixed to the surface 21 of the fishing rod 1 by a mounting thread (not shown) or the like. The wire guide 2 is as illustrated in FIG. 1 in flat view, and is as illustrated in FIG. 2 in front view.

The wire guide 2 is formed by bending a single wire 10. One end portion of the wire 10 is formed as a linear first leg 11 which extends toward the other second leg 15 to form a loop-like line guide portion 4 in which a bent portion 12, an arcuate portion 13, and a linear portion 14 are integrally connected with each other.

In the flat view of FIG. 1, the first and second legs 11 and 15 are bundled together and arranged side by side on the fishing rod 1. The bent portion 12, the arcuate portion 13, and the linear portion 14 integrally rise from the legs 11 and 15 at different angles with respect to the longitudinal direction C of the legs 11 and 15. The difference between the rising angles ranges from 30 degrees to 80 degrees. The portion of the arcuate portion 13 at maximum distance from the surface 21 of the fishing rod 1 is at a non-right angle θ₂ with respect to the advancing direction of A of the fishing line. The non-right angle θ₂ ranges from 45 degrees to 80 degrees. In the conventional structure, the fishing line and the guide are normally in contact with each other at a right angle (orthogonal), whereas, in this embodiment, they are normally in contact with each other at a non-right angle (non-orthogonal).

As described above, the legs 11 and 15 are bundled together so as to be fore and aft in the advancing direction A, that is, due to the difference in length therebetween, the legs 11 and 15 are bundled together so as to be deviated from each other. At the same time, as illustrated in FIG. 9, they are arranged side by side in the same plane 21a, and the linear region of the first leg 11 is longer than that of the second leg 15, with a V-shaped region 16 V-shaped in flat view being formed by the first leg 11 and the linear portion 14. Thus, as illustrated in FIG. 2, the wire guide 2 is formed in an 8-shaped configuration in front view. In the flat view of FIG. 11, the line guide portion 4 is asymmetric with respect to the center.

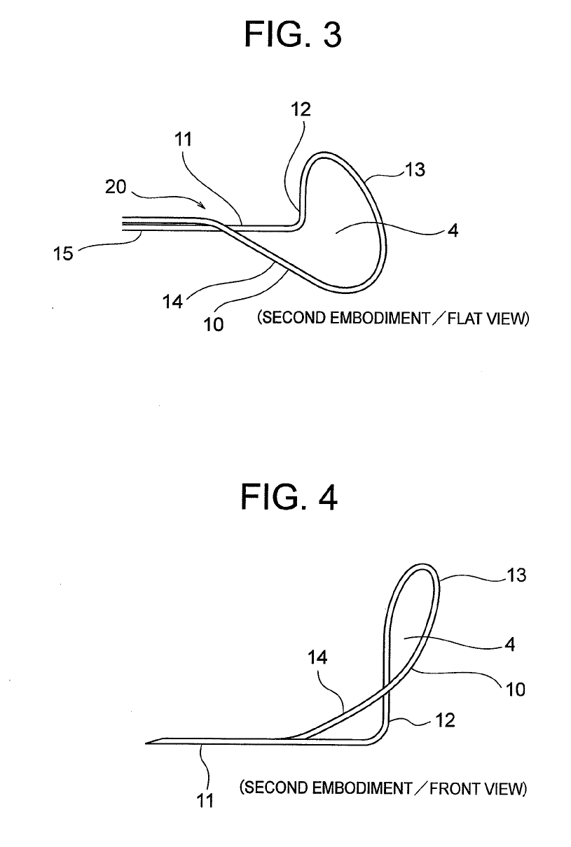

FIGS. 3 and 4 illustrate a second embodiment of the present invention, in which the second leg 15 is raised over the first leg 11 and is caused to cross the same, with the linear portion 14 and the first leg 11 forming a crossing portion 20.

The legs 11 and 15 extend on the fishing rod 1 toward the rod base B, with the legs 11 and 15 supporting the line guide portion 4 as a single leg.

The other portions are the same as those of FIGS. 1 and 2, and hence the same portions are indicated by the same reference numerals, and description thereof is omitted.

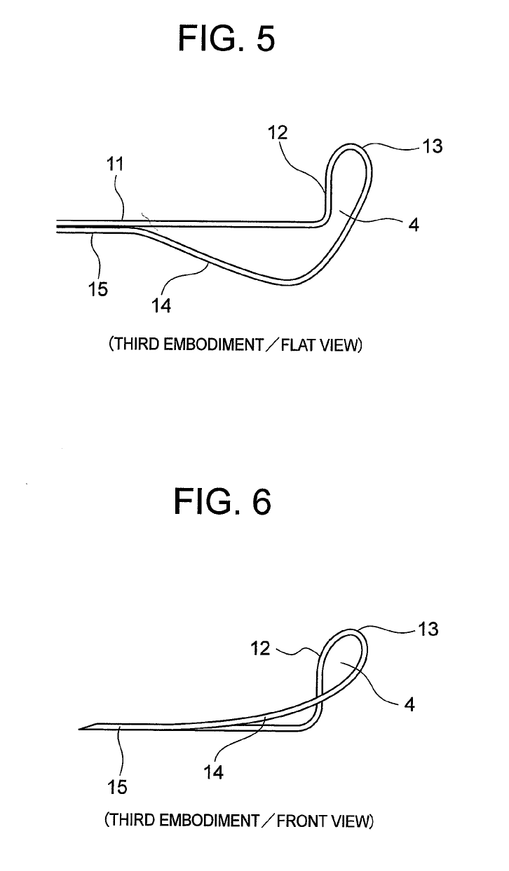

FIGS. 5 and 6 illustrate a third embodiment of the present invention, in which the configuration of the arcuate portion 13 is horizontally reversed to that of the first embodiment. The portions that are the same as or equivalent to those of FIGS. 1 and 2 are indicated by the same reference numerals and description thereof is omitted.

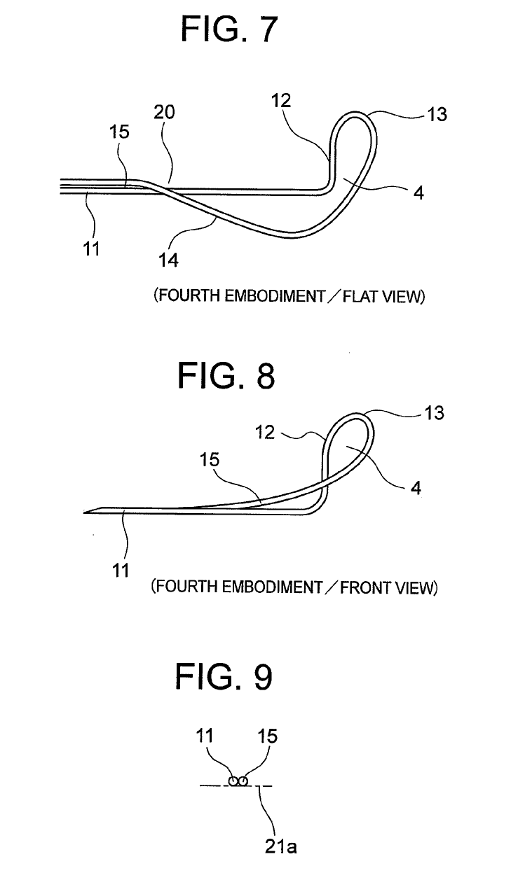

FIGS. 7 and 8 illustrate a fourth embodiment of the present invention, in which the configuration of the arcuate portion 13 is horizontally reversed to that of the second embodiment; the portions that are the same as or equivalent to those of FIGS. 3 and 4 are indicated by the same reference numerals and description thereof is omitted.

Next, a process for actually performing working on the above-mentioned wire guide 2 is described.

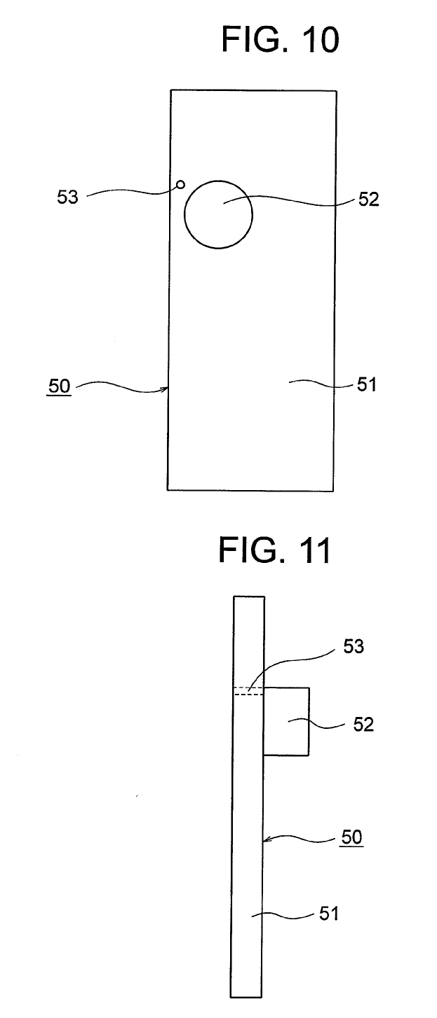

First, as the jig for performing working on the wire guide 2 of the present invention, there is used a jig 50 as illustrated in FIGS. 10 and 11.

The jig 50 is constructed of an elongated-plate-like main body 51, a column 52 provided on one side of the main body 51, and a through-hole 53 formed in the vicinity of the column 52 and extending through the main body 51 in the thickness direction thereof.

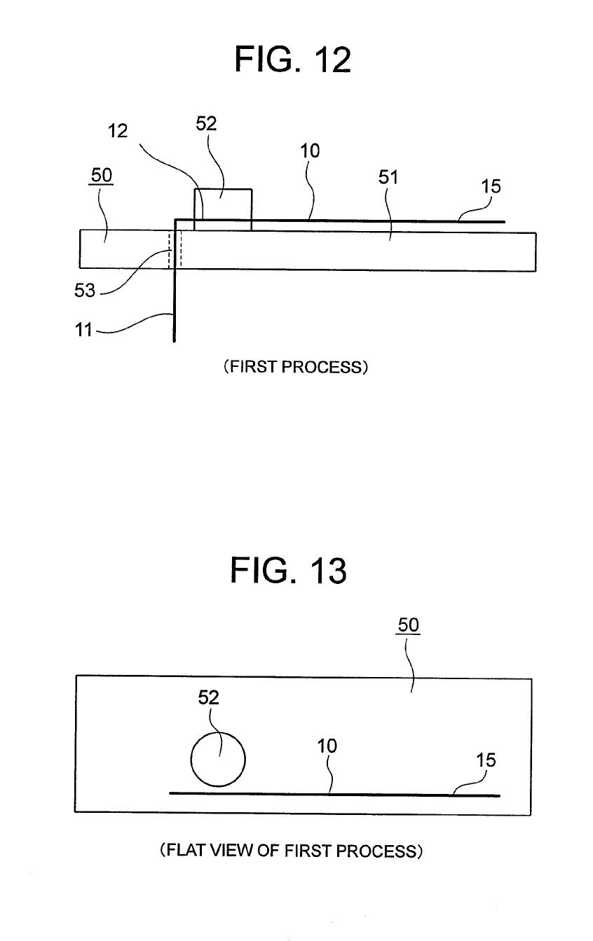

When using the above-mentioned jig 50 in a first step illustrated in FIGS. 12 and 13, one end constituting the first leg 11 of the wire 10 is passed through the through-hole 53, and the wire 10 is bent at a right angle to thereby form the bent portion 12.

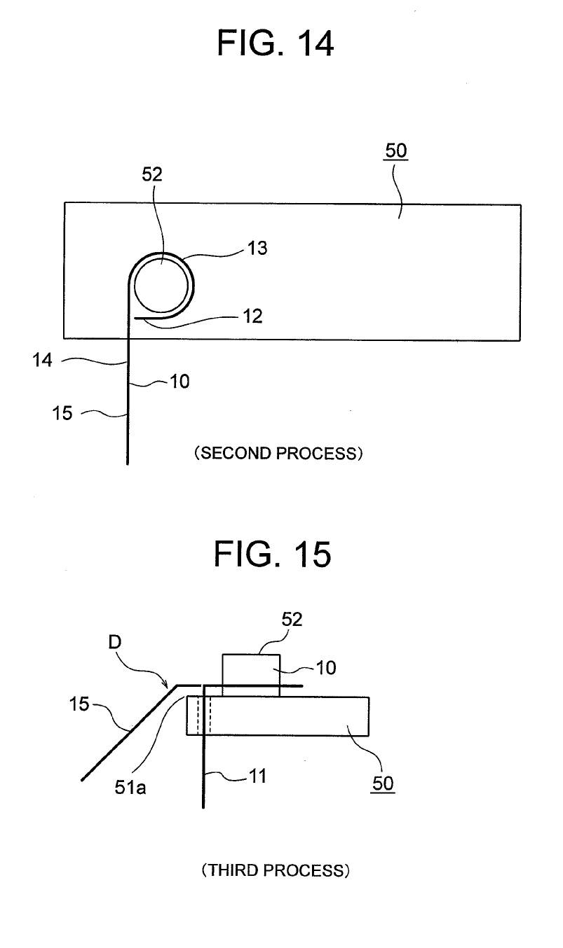

Next, in a second step illustrated in FIG. 14, the bent portion 12 is wrapped around the peripheral surface of the bent portion 12 to make a substantially one round, thereby forming the arcuate portion 13 and the linear portion 14. Then, in a third step illustrated in FIG. 15, a front portion D of the second leg 15 at the forward end of the linear portion 14 is bent by 30 to 45 degrees on a corner portion 51a of the main body 51.

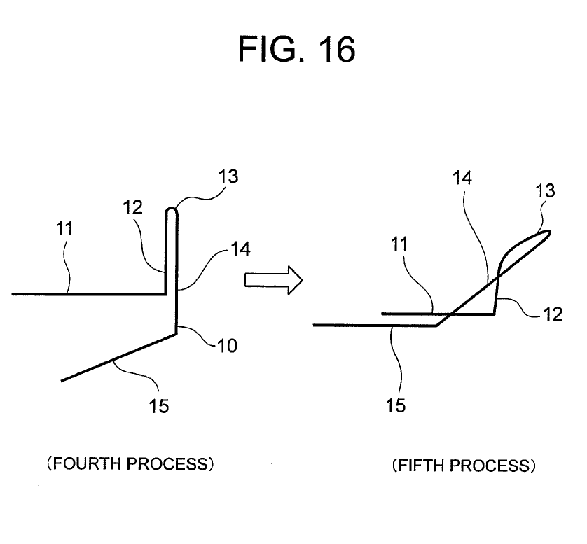

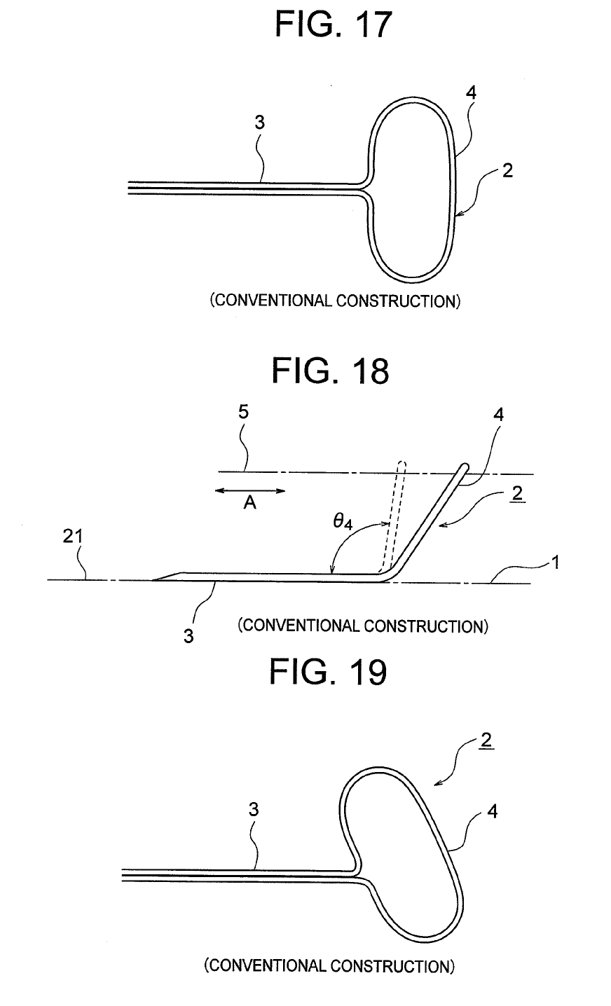

The wire 10 that has undergone the working of the first through third steps assumes a configuration akin to that of the wire guide 2, and, in a fourth step illustrated in FIG. 16, the wire 10 is detached from the jig 50.

Next, as illustrated on the right-hand side of FIG. 16, the legs 11 and 15 of the wire 10 detached from the jig 50 are forcibly aligned and arranged side by side, whereby it is possible to obtain the wire guide 2 as illustrated in FIG. 1.

What is claimed is:

1. An asymmetric one-legged wire guide for a fishing rod, comprising:
a loop-like line guide portion (4) formed by bending a single wire (10) and;
a pair of first linear leg (11) and second linear leg (15) formed respectively at both ends of the wire (10) and bundled together so as to be fore and aft with respect to each other in an advancing direction (A) of a fishing line (5) passing the line guide portion (4),
wherein an angle (θ₂) formed by a portion of the line guide portion (4) in contact with the fishing line (5) which is at maximum distance from a surface (21) of a fishing rod (1) and by a longitudinal direction (C) is an angle other than a right angle with respect to the longitudinal direction (C).

2. An asymmetric one-legged wire guide for a fishing rod according to claim 1, wherein the angle (θ₂) formed by the portion at maximum distance from the surface (21) of the fishing rod (1) and by the longitudinal direction (C) ranges from 45 degrees to 80 degrees.

3. An asymmetric one-legged wire guide for a fishing rod according to claim 1, wherein the wire (10) forming the line guide portion (4) is continuously formed by an arcuate portion (13), a bent portion (12), and a linear portion (14).

4. An asymmetric one-legged wire guide for a fishing rod according to any one of claim 1, wherein the first linear leg (11) and the second linear leg (15) of the wire (10) forming the line guide portion (4) respectively exhibit different rising angles (θ₃, θ₁) with respect to the longitudinal direction (C).

5. An asymmetric one-legged wire guide for a fishing rod according to any one of claim 1, wherein the difference between the respective rising angles (θ₃, θ₁) of the first linear leg (11) and the second linear leg (15) with respect to the longitudinal direction (C) ranges from 30 degrees to 80 degrees.

6. An asymmetric one-legged wire guide for a fishing rod according to any one of claim 1, wherein the first linear leg (11) and the second linear leg (15) are arranged side by side in the same plane (21a).

7. An asymmetric one-legged wire guide for a fishing rod according to any one of claim 1, wherein the linear portion (14) crosses the first linear leg (11) and the second linear leg (15) to form a crossing portion (20).

8. An asymmetric one-legged wire guide for a fishing rod according to any one of claim 1, wherein the line guide portion (4) is of an 8-shaped configuration in front view.

9. An asymmetric one-legged wire guide for a fishing rod according to any one of claim 1, wherein the first linear leg (11) and the second linear leg (15) extend in a direction of a rod base (B) of the fishing rod (1).
